(19) United States
(12) Patent Application Publication
(10) Pub. No.: US 2015/0294545 A1
(43) Pub. Date: Oct. 15, 2015

(54) Enhanced Low-Battery Alert and Indicator

(71) Applicant: Philip Odette, Southlake, TX (US)

(72) Inventor: Philip Odette, Southlake, TX (US)

(21) Appl. No.: 14/249,313

(22) Filed: Apr. 9, 2014

(51) Int. Cl. G08B 17/10; G08B 3/10; G08B 5/36

(52) U.S. Cl. CPC G08B 17/10; G08B 5/36; G08B 3/10

(57) ABSTRACT

The present invention provides an independent, secondary smoke detector low battery alert that detects whether an attached smoke detector has sounded a low battery warning alert and generates one or more secondary visual/audible alerts. In one embodiment of the present invention, the secondary alert comprises a flashing light. In other embodiments, colored lights, sound, including user recorded sound, and/or informative textual or graphical messages are displayed to the user.

### CROSS-REFERENCE TO RELATED APPLICATIONS

This application takes benefit of U.S. Provisional App. 61/810,762 dated Apr. 11, 2013 which is incorporated herein by reference.

### FIELD OF THE INVENTION

This invention relates generally to an independent device for use with a smoke detector to render audible and visible low-battery alerts more obvious and identifiable. The invention does this by: 1) Detecting the audible tone generated by the smoke detector when a low battery alert is sounded; and/or, 2) Detecting the mechanical vibration imparted to the housing of the smoke detector when a low battery alert is sounded.

### BACKGROUND OF THE INVENTION

All smoke detectors—be they AC line powered or battery powered, have batteries. These are used as a backup power supply in the former case and as the principle source of power in the latter case. In both cases, however, these batteries become worn and must be replaced. As a result, smoke detectors are routinely equipped with visual and audible alerts that warn the user of an impending or existing low battery condition thus prompting the user to replace the batteries as soon as possible. While many novel means of signaling the user of an impending low battery condition are known in the prior art (e.g. U.S. Pat. No. 4,228,428 (a flag that drops from the detector), U.S. Pat. No. 5,053,752 (a coiled tape of cord that uncoils and hangs from the detector)), and U.S. Pat. No. 5,574,436 (an independently powered, internally mounted secondary “missing power source indicator”), none of these may be installed after the fact on an existing smoke detector. This necessitates that the user replace the entire smoke detector a significant expense and inconvenience. As a result, it is a first objective of the present invention to provide an independent, secondary smoke detector low battery alert indicator that may be easily affixed to an existing smoke detector.

While all smoke detectors are equipped with integral visual and audible low battery alert devices, these devices are exceedingly hard to use. Anyone who has been awaked from sleep by a smoke detector low battery alert is aware of how difficult it is to locate an offending device. It is difficult to determine the direction of such devices because the audible source (usually a Sonolert® or some similar acoustic device) is extremely difficult to audibly localize. This is a particular problem when the user has more than one smoke detector. Moreover, the visual alert is usually nothing more than the flash of a light emitting diode (LED) and these are mounted on the underside of the device and difficult to see from a distance. As a result, it is a second objective of the present invention to provide an independent, secondary smoke detector low battery alert indicator that gives the user an enhanced visual and/or audible indications augmenting the visual and audible indications innately provided by the smoke detector.

### SUMMARY OF THE INVENTION

It is an object of the present invention to provide an independent, secondary smoke detector low battery alert that augments the visual and audible indications innately provided by the smoke detector. The present invention accomplishes this by providing easily perceived visual and/or audible indications that the smoke detector to which it is attached has sounded a low battery alert. In one embodiment of the present invention, the user is alerted by one or more bright flashes of light. In alternative embodiments of the present invention, these flashes of light may be colored to indicate proximity of the alert. By this means, a user with a multiplicity of smoke detectors might find the independent, secondary smoke detector low battery alert attached to the smoke detector generating the low battery alert, emitting red light, while nearby independent, secondary smoke detector low battery alert attached to nearby smoke detectors are generating amber light. By this means the user may “home in” on the offending smoke detector by finding a nearby non-offending smoke detector. In another embodiments, lights and various sounds, including a user recorded message identifying the smoke detector to which a particular independent, secondary smoke detector low battery alert is attached (e.g. “master bedroom smoke detector”) alone or in combination may be produced.

The device generally comprises a power source such as a battery, a control circuit, a sensor, and an output device. The power source is electrically connected to supply electrical power to the control circuit, the sensor, and the output device. The sensor is used to determine if the low battery alert from the attached smoke detector has been sounded. This may be done by detecting the audible signal generated by the smoke detector when it sounds an alert or by detecting the mechanical vibration generated when the smoke detector is sounded. The sensor is electrically connected to the aforementioned control circuit. The control circuit uses input from the sensor to determine if attached smoke detector has signaled a low battery condition. The control circuit is electrically connected to the output device such that the control circuit causes the output device to begin to function. The output device may be any device that performs one or more user perceptible actions. Typical user perceptible actions include, but are not limited to, flashing a light, flashing colored lights, playing sounds, or generating user perceptible graphics or messages.

In the first embodiment of the present invention, the user attaches the independent, secondary smoke detector low battery alert to the desired smoke detector. The sensor detects when the attached smoke detector low battery alert is sounded and communicates an electrical signal to the control circuit to indicate this alert. In one embodiment, the independent, secondary smoke detector low battery alert generates a single flash of light. In a second embodiment the independent, secondary smoke detector low battery alert generates a series of flashes from a single light. In a third embodiment of the present invention, the independent, secondary smoke detector low battery alert generates series of flashes of colored light wherein the selection of the color of the light indicates the intensity (and thus distance) of the perceived smoke detector low battery alert. In a fourth embodiment, the independent, secondary smoke detector low battery alert additional generates a sound or series of sounds. In a fifth embodiment, the independent, secondary smoke detector low battery alert plays a prerecorded audible message to the user. Other embodiments of the present invention provide different user perceptible indications.

### BRIEF DESCRIPTION OF THE DRAWINGS

FIG. 1 is a block diagram showing an independent, secondary smoke detector low battery alert according to a first embodiment of the present invention.

FIG. 2 is a block diagram showing an independent, secondary smoke detector low battery alert according to a second embodiment of the present invention.

FIG. 3 is a block diagram showing an independent, secondary smoke detector low battery alert according to a third embodiment of the present invention.

FIG. 4 is a block diagram showing an independent, secondary smoke detector low battery alert according to a fourth embodiment of the present invention.

### DETAILED DESCRIPTION OF THE INVENTION

The present invention improves over the prior art by providing independent, secondary smoke detector low battery alert that: 1) Detects when an attached smoke detector has sounded a low battery warning alert; and, 2) Outputs a user perceptible signal or performs a user perceptible action.

In the following description, numerous specific details regarding possible componentry are set forth (e.g., sound detectors, vibration detectors, audio filters, audio devices, lighting devices, etc.) in order to provide a thorough understanding of the invention. Those skilled in the art will recognize, however, that the invention may be practiced apart from these specific details. In other instances, details well known and widely used in the process of manufacturing miniaturized electronic devices (e.g., plastic injection molding, techniques for assembling electronic components, techniques for affixing small electronic devices to the outside housing of a second device (e.g. smoke detector), etc.) and miscellaneous components have been omitted, so as not to unnecessarily obscure the present invention.

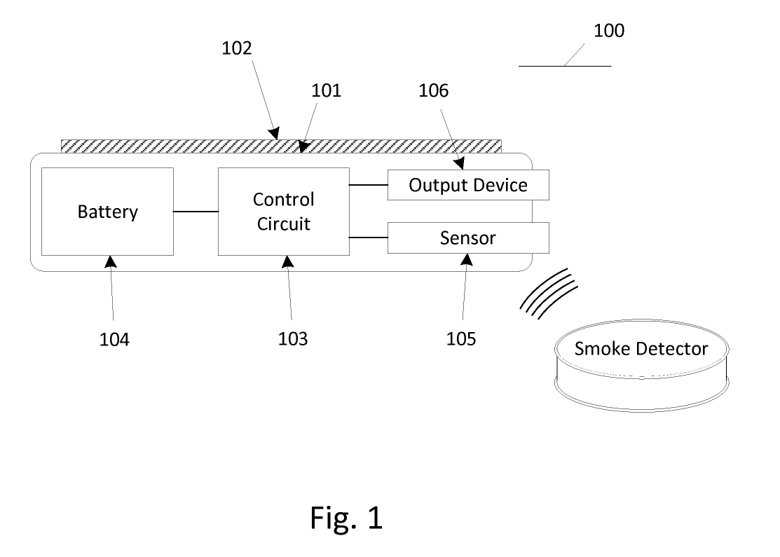

Turning now to FIG. 1 a first embodiment of independent, secondary smoke detector low battery alert 100 includes a housing 101 and an attachment device 102. Attachment device 102 is ordinarily a double sided adhesive disc, but it can also be an elastomeric strap that encircles the ordinarily round smoke detector, or indeed, included in the housing of the smoke detector itself. Housing 101 comprises control circuit 103, a power source such as a battery 104, a sensor 105, and an output device 106. Control circuit 103 is electrically coupled to battery 104, sensor 105, and output device 106. Control circuit 103 monitors the state of sensor 105 to determine if and when the attached smoke detector has sounded a low battery alert. After control circuit 103 determines that the attached smoke detector has sounded a low battery alert, control circuit 103 actuates output device 106.

Independent, secondary smoke detector low battery alert 100 may signify that the attached smoke detector has sounded a low battery in many ways. The process may be as simple as actuating output device 106 some fixed, predetermined time after sensor 105 detects the audible low battery alert generated by the attached smoke detector. In this example, the first step (detecting that the attached smoke detector has sounded a low battery alert) is ordinarily done by means of sensor 105 in the form of a sound receptor. The second step (determining when to actuate output device 106) may be done in many ways. For example, output device 106 may be actuated immediately after control circuit 103 determines that sensor 105 has sensed an audible low battery alert from the attached smoke detector. Similarly, output device 106 may be actuated after the attached smoke detector sounds a low battery alert but only after control circuit 103 has counted a predetermined amount of time after the sound emissions are recorded by sensor 105. Such an arrangement would be helpful if output device 106 generates a sound where it is desirable that the sound generated by output device 106 not coincide with the audible low battery alert sounded by the attached smoke detector. Other arrangements wherein control circuit 103 repeatedly activates output device 106 a predetermined number of times will be readily apparent.

Sensor 105 may be any type of device that could be used to detect the sounding of a low battery alert. Ordinarily, sensor 105 is a crystal microphone or any other piezoelectric transducer that converts sound to electrical current. Since the sonalerts typically used in smoke detectors generate sound at a frequency between 2.7 KHz and 3.3 KHz, sensor 105 may further include a bandpass filter to attenuate detection at frequencies outside that range. Alternately, sensor 105 may be a high-frequency piezoelectric vibration sensor that detects the natural vibration imparted to the housing of the smoke detector when the low battery alert is sounded.

Output device 106 is any type of device that performs one or more user perceptible actions, including but not limited to: 1) Lighting one or more monochromatic LEDs or lamps; 2) Lighting one or more colored LEDs or lamps; 3) Reproducing a variety of sounds including prerecorded sounds; and/or, 4) Displaying a user perceptible message or graphic. For example, output device 106 may include a light emitting device with a multiplicity of LEDs or lamps that flash in different spatial and temporal patterns and intensity. Similarly, output device 106 may additionally comprise a means of reproducing a variety of prerecorded sounds, including sounds recorded by the user. Similarly, output device 106 may be a display device capable of displaying textual or graphic messages such as an LCD. Such messages might include the elapsed amount of time the low battery condition has been sounded by the attached smoke detector, the aggregate number of soundings detected, and so on.

With the various possible sensors 105 and output devices 106 that may be used, control circuit 103 may perform operations that: 1) Need only be triggered by an initial input signal (e.g., a single sounding of a low battery alert by the attached smoke detector); and/or, 2) Need continuously acquired sensor information (e.g., counting the number of soundings made by the attached smoke detector). Control circuit 103 may further comprise non-volatile random access memory and/or working random access memory. This would allow control circuit 103 to perform certain useful tasks such as keeping a history of how long the batteries in the attached smoke detector ordinarily last. Such information would be beneficial in that the device could predictively indicate to the user when the batteries in the attached smoke detector will need to be replaced, thus allowing the user additional time to secure new batteries for the attached smoke detector.

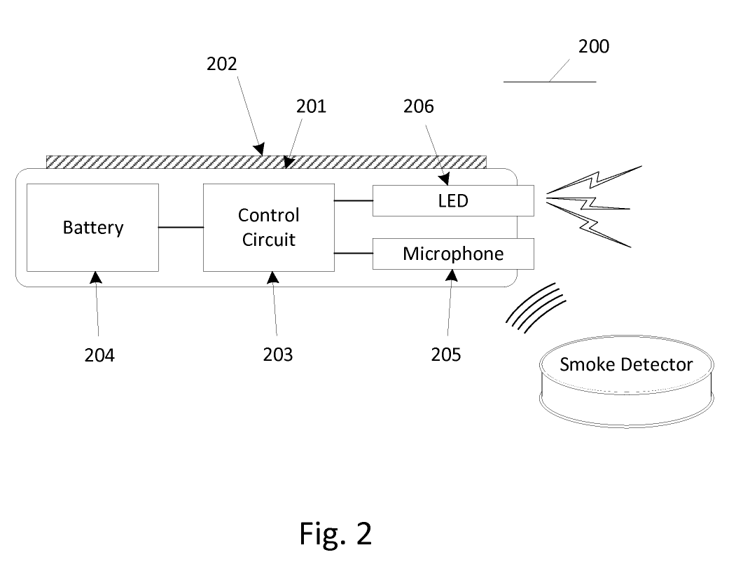

Turning now to FIG. 2 a second embodiment of independent, secondary smoke detector low battery alert 200 includes a housing 201 and an attachment device 202. Attachment device 202 is ordinarily a double sided adhesive disc but it can also be an elastomeric strap that encircles the ordinarily round smoke detector, or indeed, included in the housing of the smoke detector itself. Housing 201 comprises control circuit 203, a power source such as a battery 204, a microphone 205, and a monochromatic LED 206. As discussed above microphone 205 may be replaced with a vibration sensor to detect the mechanical vibration imparted to the housing of the smoke detector when the smoke detector sounds a low battery alert. Control circuit 203 is electrically coupled to battery 204, microphone 205, and monochromatic LED 206. Control circuit 203 monitors microphone 205 to determine if and when the attached smoke detector has sounded a low battery alert. After control circuit 203 determines that the attached smoke detector has sounded a low battery alert, control circuit 203 actuates LED 206 for a short period of time before turning it off. In a second variant of this embodiment, control circuit 203 actuates LED 206 a multiplicity of times for a preprogrammed period of time to better alert the user.

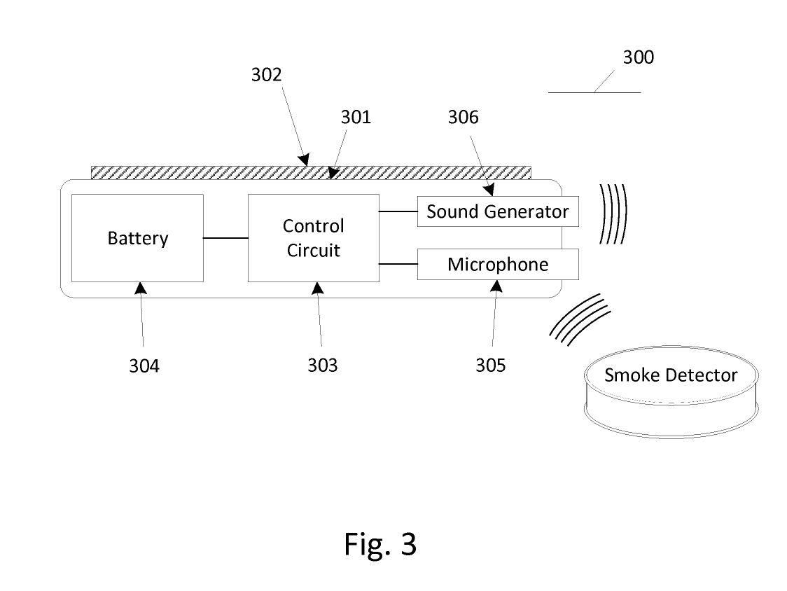

Turning now to FIG. 3 a third embodiment of independent, secondary smoke detector low battery alert 300 includes a housing 301 and an attachment device 302. Attachment device 302 is ordinarily a double sided adhesive disc but it can also be an elastomeric strap that encircles the ordinarily round smoke detector, or indeed, included in the housing of the smoke detector itself. Housing 301 comprises control circuit 303, a power source such as a battery 304, a microphone 305, and a sound generator 306. Control circuit 303 is electrically coupled to battery 304, microphone 305, and sound generator 306. As discussed above microphone 305 may be replaced with a vibration sensor to detect the mechanical vibration imparted to the housing of the smoke detector when the smoke detector sounds a low battery alert. Control circuit 303 monitors microphone 305 to determine if and when the attached smoke detector has sounded a low battery alert. After control circuit 303 determines that the attached smoke detector has sounded a low battery alert, control circuit 303 actuates sound generator 306 for a short period of time before turning it off. In a second variant of this embodiment, control circuit 303 actuates sound generator 306 a multiplicity of times for a preprogrammed period of time to better alert the user. In a third variant of this embodiment, sound generator 306 is of the kind commonly known (e.g. a chip on board device with a HK828 sound recorder/playback integrated circuit and integral speaker) wherein the user prerecords a spoken message. This variant additionally comprises a switch or other means of signaling to sound generator to begin the recording sequence. Messages recorded ordinarily would indicate the location of the smoke detector (e.g. “master bedroom smoke detector”).

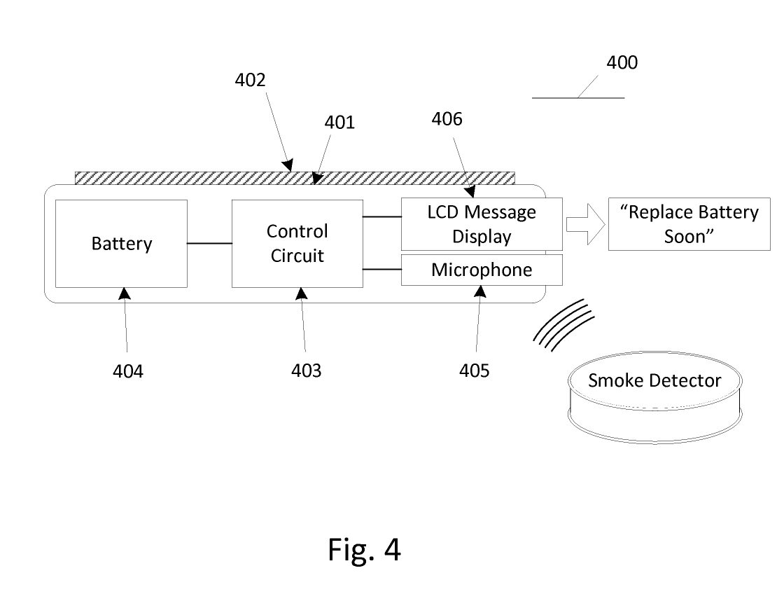

Turning now to FIG. 4 a forth embodiment of independent, secondary smoke detector low battery alert 400 includes a housing 401 and an attachment device 402. Attachment device 402 is ordinarily a double sided adhesive disc but it can also be an elastomeric strap that encircles the ordinarily round smoke detector, or indeed, included in the housing of the smoke detector itself. Housing 401 comprises control circuit 403, a power source such as a battery 404, a microphone 405, and a LCD message display 406. As discussed above microphone 405 may be replaced with a vibration sensor to detect the mechanical vibration imparted to the housing of the smoke detector when the smoke detector sounds a low battery alert. Control circuit 403 is electrically coupled to battery 404, microphone 405, and LCD message display 406. Control circuit 403 monitors microphone 405 to determine if and when the attached smoke detector has sounded a low battery alert. After control circuit 403 determines that the attached smoke detector has sounded a low battery alert, control circuit 403 actuates LCD message display 406 for a short period of time before turning it off. An appropriate message in this example might be to alert the user to replace the battery in the smoke detector soon. In a second variant of this embodiment, control circuit 403 actuates LCD message display 406 a multiplicity of times for a preprogrammed period of time to better alert the user. In a third variant of this embodiment, control circuit 403 counts the number of time the low battery alert has been sounded by the attached smoke detector and actuates LCD message display 406 causing it to display the aggregate number of times the low battery alert has been sounded by the attached smoke detector. In a fourth variant of this embodiment, control circuit 403 records the aggregate amount of time that has elapsed between the first sounding of the low battery alert by the attached smoke detector and the present time and actuates LCD message display 406 causing it to display the aggregate time the alerts have been sounded. In a fifth variant of this embodiment, control circuit 403 records the aggregate amount of time that has elapsed between the first series of soundings of the low battery alert by the attached smoke detector and a subsequent series of soundings of the low battery alert by the attached smoke detector and actuates LCD message display 406 some arbitrary time before the expected next series of soundings of the low battery alert by the attached smoke. By this means, the user is provided a visual indication that the batteries in the attached smoke detector are expected to require replacement soon, and the user should acquire new batteries as soon as possible. This variant additionally comprises a switch or other means of signaling to control circuit 403 that the batteries have been replaced. When the batteries are replaced and the switch pressed to communicate to control circuit 403 that the batteries have in fact been replaced, control circuit 403 begins to record elapsed time until the next battery replacement is required, whereupon it again actuates LCD message display 406 some arbitrary time before the expected next series of soundings of the low battery alert by the attached smoke detector.

Those skilled in the art will recognize that numerous alternative output devices other than those explicitly described are available to provide one or more stimuli to the user and/or another device and that all such output devices are implicitly included within the spirit and scope of the present invention. This includes, but is not limited to, output devices that emit radio frequency or infrared signals to communicate information to other devices.

What is claimed is:

1. An independent, secondary smoke detector low battery alert comprising a housing, said housing internally further comprising:
a. a source of electrical power;
b. a sensor capable of detecting that a smoke alarm has sounded an alert;
c. an output device capable of generating at least one user perceptible action; and,
d. a control circuit capable of determining from said sensor whether said smoke detector has sounded an alarm and capable of causing said output device to generate said user perceptible action.

2. An independent, secondary smoke detector low battery alert of claim 1 wherein said source of electrical power is a battery.

3. An independent, secondary smoke detector low battery alert of claim 1 wherein said source of electrical power is a mains voltage to low voltage power adapter.

4. An independent, secondary smoke detector low battery alert of claim 1 wherein said sensor is an acoustic transducer.

5. An independent, secondary smoke detector low battery alert of claim 1 wherein said sensor is a vibration detector.

6. An independent, secondary smoke detector low battery alert of claim 1 wherein said output device generates a light.

7. An independent, secondary smoke detector low battery alert of claim 6 wherein said output device generates colored light.

8. An independent, secondary smoke detector low battery alert of claim 1 wherein said output device generates a sound, including a user recorded sound.

9. An independent, secondary smoke detector low battery alert of claim 1 wherein said output device generates a user recorded sound.

10. An independent, secondary smoke detector low battery alert of claim 1 wherein said output device is capable of generating a user perceptible textual message.

11. An independent, secondary smoke detector low battery alert of claim 1 wherein said output device is capable of generating a user perceptible graphical display.

12. An independent, secondary smoke detector low battery alert for signaling whether a smoke detector has generated a sound comprising a housing, said housing internally further comprising:
a. a source of electrical power;
b. a sensor capable of detecting that a smoke alarm has sounded an alert;
c. an output device capable of flashing a sequence of lights;
d. a control circuit capable of determining from said sensor whether said smoke alarm has generated a sound and subsequently actuating said output device.

13. An independent, secondary smoke detector low battery alert of claim 12 wherein said control circuit causes said output device to flash a sequence of lights for 10 seconds.

14. An independent, secondary smoke detector low battery alert of claim 12 wherein said output device also generates audible information.

15. An independent, secondary smoke detector low battery alert of claim 12 wherein said output device also generates colored lights.

16. An independent, secondary smoke detector low battery alert of claim 12 wherein said output device also generates a user perceptible textual message.

17. An independent, secondary smoke detector low battery alert of claim 12 wherein said output device also generates a user perceptible graphical display.
